(19) United States
(12) Patent Application Publication
(10) Pub. No.: US 2018/0173222 A1
(43) Pub. Date: Jun. 21, 2018

(54) AUTOMATIC DRIVING ASSISTANT SYSTEM AND METHOD THEREOF

(71) Applicant: Primax Electronics Ltd., Taipei (TW)

(72) Inventors: YING-CHE TSENG, Taipei (TW); CHENG -YI TSAI, Taipei (TW)

(21) Appl. No.: 15/596,120

(22) Filed: May 16, 2017

(30) Foreign Application Priority Data
Dec. 21, 2016 (CN) 201611191750.7

(51) Int. Cl. G05D 1/00; H04N 7/18; G06K 9/00; H04N 9/31; G01C 21/36; G05D 1/02; B64C 39/02

(52) U.S. Cl. CPC G05D 1/0044; H04N 7/183; G06K 9/0063; H04N 9/3173; G01C 21/3602; B64C 2201/146; G05D 1/0238; G05D 1/0246; B64C 39/024; B64C 2201/127; G05D 1/0088

(57) ABSTRACT

The present invention provides an automatic driving assistant system, which is applied to a vehicle and includes: a navigation apparatus; an aerial photography apparatus, and an electronic apparatus. The navigation apparatus generates a plurality of paths according to a positioning signal. The aerial photography apparatus is configured to fly to a default distance range to capture an environment image. The navigation apparatus receives the environment image from the aerial photography apparatus and analyzes the environment image, and then generates an alternative path according to the environment image and the paths. The electronic apparatus is wirelessly connected to the navigation apparatus to select one of the paths or the alternative path. The vehicle moves according to one of the paths or the alternative path.

### FIELD OF THE INVENTION

The present invention relates to the field of driving assistant applications, and in particular, to an automatic driving assistant system and method.

### BACKGROUND OF THE INVENTION

An autonomous car is an automatic vehicle. Compared with a car driven by a human who uses only sensing capabilities such as vision and hearing, an autonomous car combines multiple active and passive sensors to sense change of surroundings and quickly make response to a possible danger or accident, thereby lowering the probability of traffic accidents.

In recently years, with the development of autonomous car technologies, countries including Belgium, France, Italy, and UK have planned to put autonomous cars into operation of traffic and transportation systems, and countries including Germany, Netherlands, and Spain have allowed autonomous cars to drive on roads experimentally.

Although autonomous cars have multiple different sensors, because they can only be arranged outside the car body, this design limits a sensing range of the sensors. When an accident or traffic jam happens at a location far from an autonomous car, because of the long distance, the sensors in the autonomous car system cannot obtain real-time road condition information of the location. As a result, the autonomous car system cannot make a response in time, and a user of the autonomous car is brought into a dangerous environment or has a delay in time because of traffic jam.

In view of the above, how to provide an automatic driving assistant system having an extended detection distance is a technical problem to be resolved in the present invention.

### SUMMARY OF THE INVENTION

A main objective of the present invention is to provide an automatic driving assistant system having an extended detection distance, and use an electronic apparatus to remotely control a vehicle in which the automatic driving assistant system is installed to move, so that a user can remotely pick up a car, to save time for a user to look for a parking spot or pick up a car.

To achieve the foregoing objective, the present invention provides an automatic driving assistant system, applied to a vehicle and including: a navigation apparatus, including: a positioning module, configured to receive a positioning signal; a first control module, configured to generate a plurality of paths according to the positioning signal; and a first wireless module; an aerial photography apparatus, including: an image capture module, configured to capture an environment image; a second control module, configured to control the aerial photography apparatus to fly to a default distance range to capture the environment image; and a second wireless module; and an electronic apparatus, where the first wireless module of the navigation apparatus is wirelessly connected to the second wireless module of the aerial photography apparatus to receive the environment image from the aerial photography apparatus, the first control module analyzes the environment image and generates an alternative path according to the environment image and the plurality of paths, the electronic apparatus is wirelessly connected to the first wireless module of the navigation apparatus to select one of the plurality of paths or the alternative path, and the vehicle moves according to one of the plurality of paths or the alternative path.

In the foregoing exemplary embodiment, the electronic apparatus is: a laptop, a tablet computer, a personal digital assistant, a mobile phone, a watch, or a game console.

In the foregoing exemplary embodiment, the first wireless module and the second wireless module are: infrared transmission modules, Bluetooth modules, ZigBee wireless network modules, or Wi-Fi transmission modules.

In the foregoing exemplary embodiment, the aerial photography apparatus further includes a projection module, and the projection module is configured to project an indication image on any surface of an environment in which the vehicle is located or on any surface of car windows of the vehicle.

In the foregoing exemplary embodiment, the navigation apparatus further includes a projection module, and the projection module is configured to project an indication image on any surface of an environment in which the vehicle is located or on any surface of car windows of the vehicle.

In the foregoing exemplary embodiment, the navigation apparatus further includes a display module, and the display module is configured to display the plurality of paths or the alternative path.

In the foregoing exemplary embodiment, the navigation apparatus controls the vehicle to move according to one of the plurality of paths or the alternative path.

In the foregoing exemplary embodiment, the electronic apparatus controls the vehicle to move according to one of the plurality of paths or the alternative path.

In the foregoing exemplary embodiment, the second wireless module of the aerial photography apparatus establishes a connection with the first wireless module of the navigation apparatus, so that the aerial photography apparatus keeps a preset distance range with the vehicle during flying.

Another exemplary implementation of the present invention relates to an automatic driving assistant method, applied to a vehicle, where the automatic driving assistant method includes the following steps:

(a) setting coordinates of a terminal point;

(b) generating a plurality of paths;

(c) selecting one of the plurality of paths;

(d) starting an aerial photography apparatus to capture an environment image;

(e) analyzing the environment image to determine whether an obstacle exists in a path along which the vehicle moves, if not, selecting to drive the vehicle manually/automatically, and if yes, performing the next step; and

(f) generating an alternative path, where the vehicle moves according to the alternative path or one of the plurality of paths.

### BRIEF DESCRIPTION OF THE DRAWINGS

FIG. 1 is an automatic driving assistant system according to the present invention;

FIG. 2 is a flowchart of processing of an automatic driving assistant system according to the present invention;

FIG. 3A is a side view of a flying distance range of an aerial photography apparatus according to the present invention;

FIG. 3B is a top view of a flying distance range of an aerial photography apparatus according to the present invention;

FIG. 4A is a schematic diagram of performing projection by using an aerial photography apparatus according to the present invention;

FIG. 4B is a schematic diagram of performing road surface projection by using an aerial photography apparatus according to the present invention;

FIG. 4C is a schematic diagram of performing car window projection by using a navigation apparatus according to the present invention;

FIG. 5A and FIG. 5B are schematic diagrams of path correction of an automatic driving assistant system according to the present invention; and

FIG. 6 is a schematic diagram of using an automatic driving assistant system according to the present invention to remotely pick up a car.

### DETAILED DESCRIPTION OF THE PREFERRED EMBODIMENT

Advantages, features, and methods for achieving them of the present invention are more easily understood through detailed description with reference to exemplary embodiments and accompanying drawings. However, the present invention can be implemented in different forms and should not be understood as being limited to the embodiments described herein. On the contrary, for a person of ordinary skill in the art, the provided embodiments make the present disclosure to more thoroughly, comprehensively, and completely convey the scope of the present invention.

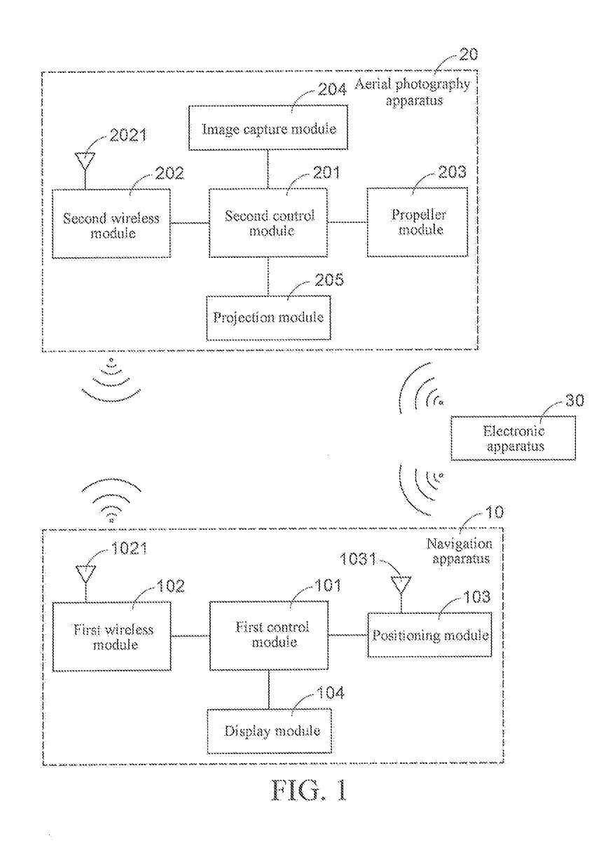

First, referring to FIG. 1, FIG. 1 is an automatic driving assistant system according to the present invention, and the automatic driving assistant system is installed in a vehicle. In an exemplary embodiment of the present invention, the automatic driving assistant system includes: a navigation apparatus 10, an aerial photography apparatus 20, and an electronic apparatus 30. The navigation apparatus 10 includes: a first control module 101, a first wireless module 102, a positioning module 103, and a display module 104. The positioning module 103 includes a positioning antenna 1031, configured to receive a signal sent by the Global Positioning System (GPS). The first control module 101 obtains by operation, according to the GPS signal, start coordinates at which the navigation apparatus 10 is located. Then after a user sets coordinates of a terminal point, the first control module 101 generates a plurality of paths according to the start coordinates of the navigation apparatus 10 and the terminal point coordinates set by the user. The display module 104 is configured to display the plurality of paths generated by the first control module 101. The first wireless module 102 includes a first wireless antenna 1021, wirelessly connected to the aerial photography apparatus 20 or the electronic apparatus 30. After the plurality of paths is generated, the user may select one of the plurality of paths by using the electronic apparatus 30 or the display module 104 having a touch control function (not shown in the figure), and then the vehicle starts moving according to the selected path.

The aerial photography apparatus 20 may be a multi-rotor, an airship, a glider, or an aerial photography balloon. In an exemplary embodiment of the present invention, the aerial photography apparatus 20 includes: a second control module 201, a second wireless module 202, a propeller module 203, an image capture module 204, and a projection module 205. The second wireless module 202 includes a second wireless antenna 2021, wirelessly connected to the navigation apparatus 10 or the electronic apparatus 30. The image capture module 204 may be an optical image capture module, an infrared image capture module, or a combination thereof. In daytime or when light is enough, the aerial photography apparatus 20 may use the optical image capture module to capture an image. At night or when light is weak, the aerial photography apparatus 20 may use the infrared image capture module to capture an image. The image capture module 204 may capture an environment image within a range of 50 meters from an environment at which the vehicle is located. The second control module 201 transmits the environment image to the navigation apparatus 10 or the electronic apparatus 30 by means of the second wireless module 202. In an exemplary embodiment, the second control module 201 transmits the environment image once at an interval of 50 milliseconds (ms) to the navigation apparatus 10 or the electronic apparatus 30 to update the environment image.

In addition, the second control module 201 may control the propeller module 203 so that the aerial photography apparatus 20 flies to a default distance range to capture an environment image of a larger range. The projection module 205 is a micro-projector and is configured to project an indication image on any surface of an environment in which the vehicle is located or on any surface of car windows of the vehicle. In an exemplary embodiment, the projection module 205 may project the indication image to 25 to 50 meters in front of a driving sight of the vehicle. The projection module 205 of the present invention may also be arranged on a vehicle body other than being arranged on the aerial photography apparatus 20 and is electrically connected to the navigation apparatus 10, and is not limited to being arranged on the aerial photography apparatus 20. The first wireless module and the second wireless module of the present invention are: infrared transmission modules, Bluetooth modules, ZigBee wireless network modules, or Wi-Fi transmission modules.

Then referring to FIG. 1 again, after the navigation apparatus 10 receives the environment image, the first control module 101 starts analyzing the environment image and generates an alternative path according to the environment image and the original plurality of paths. The user may select to make the vehicle move according to one of the originally selected plurality of paths or move according to the alternative path. In the present invention, the electronic apparatus 30 may be: an electronic device having a wireless communication module such as a laptop, a tablet computer, a personal digital assistant, a mobile phone, a watch, or a game console. The electronic apparatus 30 may be configured to set system parameters of the navigation apparatus 10 and the aerial photography apparatus 20. On the other hand, the electronic apparatus 30 may receive path data generated by the navigation apparatus 10 or the environment image captured by the aerial photography apparatus 20 in a wireless connection manner. Besides, in addition to path selection, when the electronic apparatus 30 is wirelessly connected to the navigation apparatus 10, the electronic apparatus 30 may be used as a remote control apparatus, and the user may remotely control movement of the vehicle in a manual manner by operating the electronic apparatus 30.

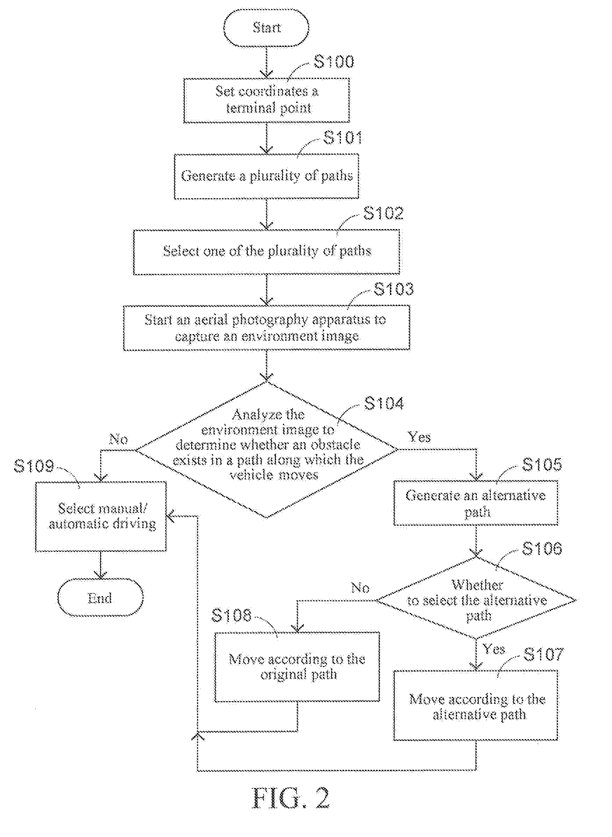

Referring to FIG. 1 and FIG. 2, FIG. 2 is a flowchart of processing of an automatic driving assistant system of the present invention. First, the user may use the display module 104 having a touch control function (not shown in the figure) of the navigation apparatus 10 or the electronic apparatus 30 to set coordinates of a terminal point (step S100). In step S100, the positioning module 103 obtains by operation, according to a GPS signal, start coordinates at which the navigation apparatus 10 is located, and then the user may set coordinates of the terminal point. Then, the first control module 101 of the navigation apparatus 10 generates a plurality of paths according to the start coordinates of the navigation apparatus 10 and the terminal point coordinates (step S101), and transmits data such as the plurality of paths to the electronic apparatus 30 or displays the data on the display module 104 of the navigation apparatus 10; the user may select one of the plurality of paths by means of the electronic apparatus 30 or the display module 104 having a touch control function (not shown in the figure) (step S102). In step S102, after the user decides the path, the vehicle moves according to the selected path and synchronously starts the aerial photography apparatus 20 to capture an environment image (step S103). In step S103, the image capture module 204 of the aerial photography apparatus 20 may capture an environment image within a range of 50 meters from an environment at which the vehicle is located, and transmits the environment image at an interval of 50 milliseconds (ms) to the navigation apparatus 10 to update the environment image; the first control module 101 of the navigation apparatus 10 analyzes the environment image to determine whether an obstacle exists in a path along which the vehicle moves (step S104). In step S104, if it is determined that no obstacle exists in the path along which the vehicle moves, the user may continue to select manual/automatic driving (step S109). In step S109, if the user selects manual driving, the user may operate a steering wheel of the vehicle to control the vehicle to move, or use the electronic apparatus 30 as a remote control apparatus and remotely control the vehicle to move in a manual manner by operating the electronic apparatus 30; if the user selects automatic driving, the vehicle is controlled by the navigation apparatus 10 to move. If it is determined in step S104 that an obstacle exists in the path along which the vehicle moves, an alternative path is generated according to data such as the environment image and the plurality of paths (step S105), and the user may decide whether to select the alternative path (step S106). If the alternative path is selected, the vehicle moves according to the alternative path (step S107). If the alternative path is not selected, the vehicle moves according to the original path (step S108). It should be noted that in step S106, if the user does not perform an operation to decide whether to select the alternative path within a preset time, according to a preset setting, the navigation apparatus 10 may automatically select to move according to the original path or move according to the alternative path. At last, return to step S109.

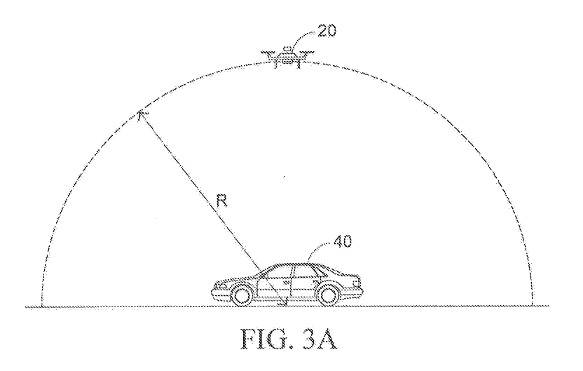

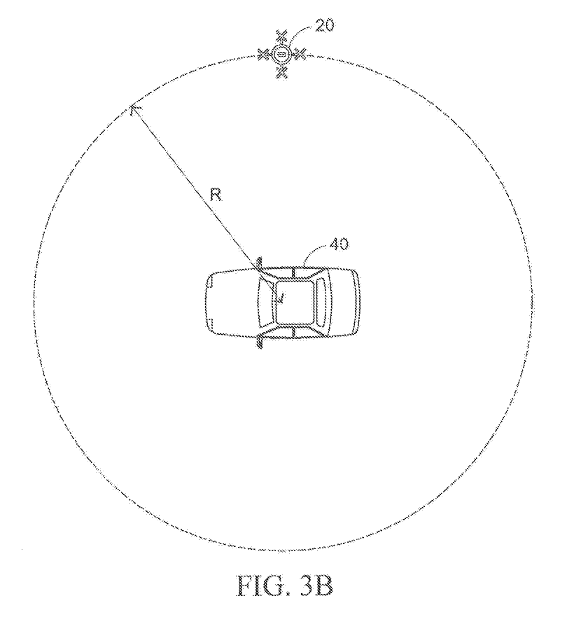

Referring to FIG. 3A and FIG. 3B, FIG. 3A is a side view of a flying distance range of an aerial photography apparatus according to the present invention, and FIG. 3B is a top view of a flying distance range of an aerial photography apparatus according to the present invention. In FIG. 3A and FIG. 3B, the aerial photography apparatus 20 is wirelessly connected to the first wireless module 102 of the navigation apparatus 10 by means of the second wireless module 202 to perform a positioning action, so that the aerial photography apparatus 20 may keep a stable distance with the moving vehicle 40 during flying. The vehicle 40 is used as a center, and a default distance range R of flying of the aerial photography apparatus 20 is within 0.1 meter to 100 meters.

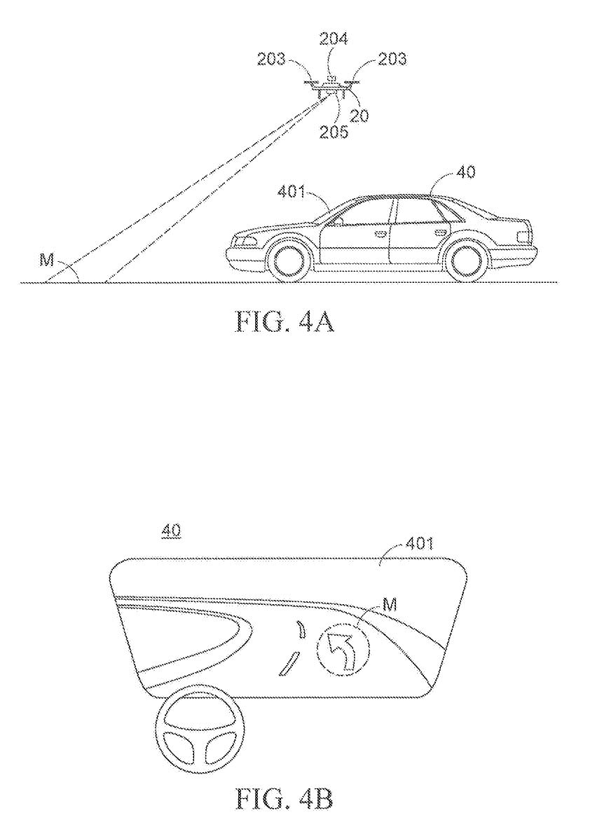

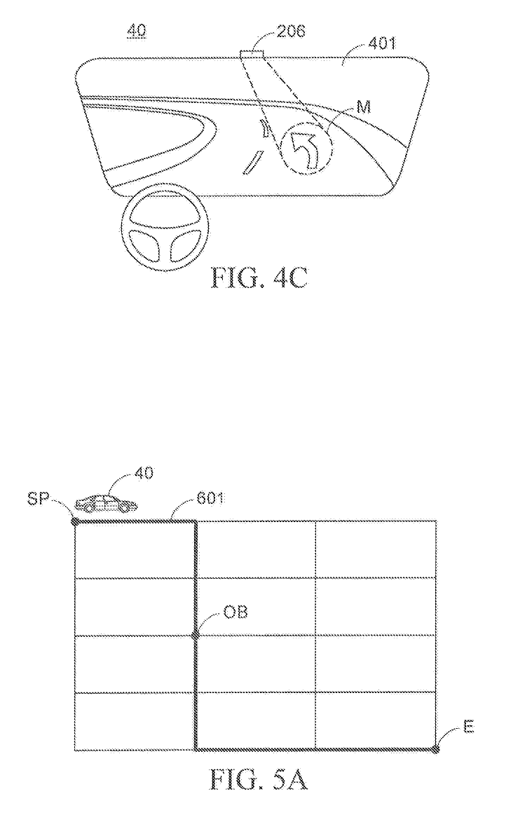

Referring to FIG. 4A, FIG. 4B, and FIG. 4C, FIG. 4A is a schematic diagram of performing projection by using an aerial photography apparatus according to the present invention, FIG. 4B is a schematic diagram of performing road surface projection by using an aerial photography apparatus according to the present invention, and FIG. 4C is a schematic diagram of performing car window projection by using a navigation apparatus according to the present invention. In FIG. 4A, the propeller module 203, the image capture module 204, and the projection module 205 of the aerial photography apparatus 20 are the same as those in FIG. 1 and are not described again here. The projection module 205 may project an indication image M on a road surface in front of the vehicle. In FIG. 4B, the user in the vehicle 40 can see the indication image M displayed on the road surface 25 to 50 meters in the front through a front windshield 401, so that the user may know a current moving direction of the vehicle 40 in real time. In addition, as shown in FIG. 4C, another projection module 206 may be disposed at the top of the front windshield 401 of the vehicle 40. The projection module 206 is electrically connected to the navigation apparatus 10 (not shown in the figure), and projects the indication image M on the front windshield 401 of the vehicle, so that the user may know a current moving direction of the vehicle 40. In addition to being arranged on the aerial photography apparatus 20 or being arranged on the vehicle 40 and electrically connected to the navigation apparatus 10 (not shown in the figure), the projection apparatus of the present invention may also project the indication image M on any surface of an environment in which the vehicle is located or on any surface of car windows of the vehicle, and is not limited to projecting the indication image on a road surface.

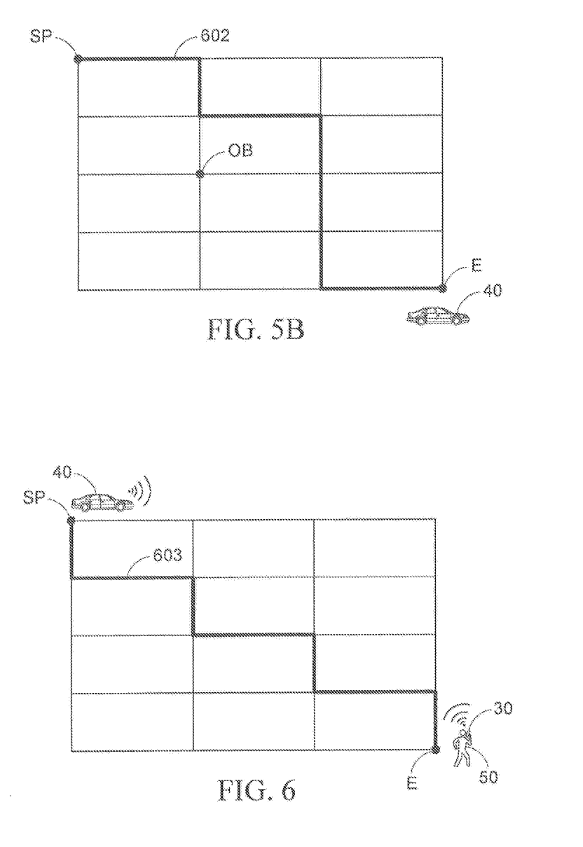

Referring to FIG. 5A and FIG. 5B, FIG. 5A and FIG. 5B are schematic diagrams of path correction of an automatic driving assistant system according to the present invention. In FIG. 5A, the vehicle 40 is located at start coordinates SP and moves to terminal point coordinates E along a path 601. In this case, the automatic driving assistant system detects, by using the aerial photography apparatus, that an obstacle OB exists on the path 601. Then, in FIG. 5B, the automatic driving assistant system immediately corrects the path and generates an alternative path 602, and the vehicle 40 moves to the terminal point coordinates E along the alternative path 602.

Referring to FIG. 6, FIG. 6 is a schematic diagram of using an automatic driving assistant system according to the present invention to remotely pick up a car. The vehicle 40 is located at the remote start coordinates SP. In this case, the user 50 located at the terminal point coordinates E may be wirelessly connected to the automatic driving assistant system (not shown in the figure) installed on the vehicle 40 by using the electronic apparatus 30, and controls the vehicle 40 to move along the path 603 to the terminal point coordinates E at which the user 50 is located, thereby achieving the objective of remotely picking up a car.

Compared with conventional technologies, the automatic driving assistant system provided in the present invention extends the sensing distance of sensors by using the aerial photography apparatus, enables a vehicle to know the road condition in advance before reaching a road on which an accident or traffic jam happens, and immediately corrects a path, so that the vehicle avoids the road on which an accident or traffic jam happens, and the vehicle moves to a destination without obstacles. On the other hand, the user may remotely control, by means of the electronic apparatus, the vehicle in which the automatic driving assistant system is installed, so that the vehicle can move from a remote location to the position at which the user is located, greatly saving time for a user to look for a parking spot or pick up a car. Therefore, the present invention is a creation having great industrial values.

Various modifications can be made to the present disclosure by a person skilled in the art without departing from the protection scope of the appended claims.

What is claimed is:

1. An automatic driving assistant system, applied to a vehicle and comprising:
a navigation apparatus, comprising:
a positioning module, configured to receive a positioning signal;
a first control module, configured to generate a plurality of paths according to the positioning signal; and
a first wireless module;
an aerial photography apparatus, comprising:
an image capture module, configured to capture an environment image;
a second control module, configured to control the aerial photography apparatus to fly to a default distance range to capture the environment image; and
a second wireless module; and
an electronic apparatus, wherein
the first wireless module of the navigation apparatus is wirelessly connected to the second wireless module of the aerial photography apparatus to receive the environment image from the aerial photography apparatus, the first control module analyzes the environment image and generates an alternative path according to the environment image and the plurality of paths, the electronic apparatus is wirelessly connected to the first wireless module of the navigation apparatus to select one of the plurality of paths or the alternative path, and the vehicle moves according to one of the plurality of paths or the alternative path.

2. The automatic driving assistant system according to claim 1, wherein the electronic apparatus is: a laptop, a tablet computer, a personal digital assistant, a mobile phone, a watch, or a game console.

3. The automatic driving assistant system according to claim 1, wherein the first wireless module and the second wireless module are: infrared transmission modules, Bluetooth modules, ZigBee wireless network modules, or Wi-Fi transmission modules.

4. The automatic driving assistant system according to claim 1, wherein the aerial photography apparatus further comprises a projection module, and the projection module is configured to project an indication image on any surface of an environment in which the vehicle is located or on any surface of car windows of the vehicle.

5. The automatic driving assistant system according to claim 1, wherein the navigation apparatus further comprises a projection module, and the projection module is configured to project an indication image on any surface of an environment in which the vehicle is located or on any surface of car windows of the vehicle.

6. The automatic driving assistant system according to claim 1, wherein the navigation apparatus further comprises a display module, and the display module is configured to display the plurality of paths or the alternative path.

7. The automatic driving assistant system according to claim 1, wherein the navigation apparatus controls the vehicle to move according to one of the plurality of paths or the alternative path.

8. The automatic driving assistant system according to claim 1, wherein a user controls, by means of the electronic apparatus, the vehicle to move according to one of the plurality of paths or the alternative path.

9. The automatic driving assistant system according to claim 1, wherein the second wireless module of the aerial photography apparatus establishes a connection with the first wireless module of the navigation apparatus, so that the aerial photography apparatus keeps a preset distance range with the vehicle during flying.

10. An automatic driving assistant method, applied to a vehicle, wherein the automatic driving assistant method comprises the following steps:
(a) setting coordinates of a terminal point;
(b) generating a plurality of paths;
(c) selecting one of the plurality of paths;
(d) starting an aerial photography apparatus to capture an environment image;
(e) analyzing the environment image to determine whether an obstacle exists in a path along which the vehicle moves, if not, selecting to drive the vehicle manually/automatically and if yes, performing the next step; and
(f) generating an alternative path, wherein the vehicle moves according to the alternative path or one of the plurality of paths.
